(19) United States
(12) Patent Application Publication
(10) Pub. No.: US 2019/0205816 A1
(43) Pub. Date: Jul. 4, 2019

(54) CARSHARING SYSTEM, INFORMATION PROCESSING DEVICE FOR CARSHARING, INFORMATION PROCESSING METHOD FOR CARSHARING, AND STORAGE MEDIUM ON WHICH PROGRAM FOR CARSHARING IS STORED

(71) Applicant: TOYOTA JIDOSHA KABUSHIKI KAISHA, Toyota-shi (JP)

(72) Inventors: Shin SAKURADA, Toyota-shi (JP); Koichi ANDO, Nagoya-shi (JP); Mutsumi MATSUURA, Okazaki-shi (JP); Masato ENDO, Nagakute-shi (JP); Koki FUJITA, Suginami-ku (JP)

(73) Assignee: TOYOTA JIDOSHA KABUSHIKI KAISHA, Toyota-shi (JP)

(21) Appl. No.: 16/165,009

(22) Filed: Oct. 19, 2018

(30) Foreign Application Priority Data
Dec. 28, 2017 (JP) 2017-255016

(51) Int. Cl. G06Q 10/08; G07C 9/00; G06Q 20/14

(52) U.S. Cl. CPC G06Q 10/083; G06Q 20/14; G07C 9/00571

(57) ABSTRACT

A carsharing system includes a server configured to: acquire a piece of vehicle movement request information about a request regarding a movement of a vehicle; acquire a piece of movement applicant information about an application for a movement using a vehicle; and issue a piece of key information, which is for temporarily unlocking or locking the vehicle and allowing the vehicle to move, to a movement applicant based on the vehicle movement request information and the movement applicant information.

### INCORPORATION BY REFERENCE

The disclosure of Japanese Patent Application No. 2017-255016 filed on Dec. 28, 2017 including the specification, drawings and abstract is incorporated herein by reference in its entirety.

### BACKGROUND

### 1. Technical Field

The disclosure relates to a carsharing system, an information processing device for carsharing, an information processing method for carsharing, and a computer readable storage medium on which a program for carsharing is stored.

### 2. Description of Related Art

A technique for enabling delivery of a delivery object even when a receiver is absent by registering a receiving vehicle in which the receiver receives the delivery object in advance and accommodating the delivery object in a trunk of the registered receiving vehicle has been proposed (for example, see Japanese Unexamined Patent Application Publication No. 2006-206225 (JP 2006-206225 A)).

### SUMMARY

When a vehicle which is designated as a delivery destination is located distant from the home of the receiver, the vehicle in which a delivery object is stored may be moved. In the form of carsharing, a vehicle having moved to a destination may be left at the destination. When a vehicle in which a delivery object is stored is moved or when a vehicle is left after use for carsharing, the distribution of vehicles may become unbalanced, which has to be corrected. A vehicle may be desired to be moved to a predetermined position in view of business hours or the like.

In this way, there are needs for movement of vehicles, but these needs may not be able to be appropriately met in carsharing or the like in the related art. The disclosure has been made in consideration of these circumstances and provides a technique capable of meeting needs for movement of a vehicle.

An aspect of the present disclosure relates to a carsharing system including a server configured to: acquire a piece of vehicle movement request information about a request regarding a movement of a vehicle; acquire a piece of movement applicant information about an application for a movement using a vehicle; and issue a piece of key information, which is for temporarily unlocking or locking the vehicle and allowing the vehicle to move, to a movement applicant based on the vehicle movement request information and the movement applicant information.

According to this configuration, a movement applicant having received a request for movement of a vehicle can use a mobile terminal storing issued key information as an electronic key including temporary authentication information for driving and operating the vehicle. The movement applicant can unlock the vehicle using the mobile terminal serving as an electronic key and move the vehicle to a destination which is designated by the movement request. According to the disclosure, since a movement applicant carrying a terminal having key information stored therein serves as a temporary key manager and drives and operates a vehicle, it is possible to appropriately meet needs for movement of a vehicle.

In the above aspect, the server may be configured to publish one or more pieces of the acquired vehicle movement request information as a vehicle list on a web site. According to this aspect, the movement applicant who desires movement using a vehicle is able to select a desired movement request by browsing the vehicle movement request information published on the web site.

In the above aspect, the server may be configured to: receive an application for a movement using a vehicle in the vehicle list; and acquire the movement applicant information by receiving the application for movement using the vehicle in the vehicle list. According to this aspect, it is able to collect movement applicants corresponding to the vehicles in the vehicle list

In the above aspect, the server may be configured to compare the vehicle movement request information with the movement applicant information and select a movement applicant based on a result of such a comparison. According to this aspect, it is able to adjust requirements or use conditions between the vehicle movement requests and the movement applicants.

In the above aspect, the key information may include a piece of available period information corresponding to a form of movement using the vehicle. According to this aspect, it is able to restrain use of a mobile terminal serving as an electronic key of which the available period has expired.

In the above aspect, the server may be configured to invalidate the key information issued by the server when a notification indicating that the vehicle has been locked by using the key information has been received. According to this aspect, it is able to invalidate the key information with the notification indicating the locking of the vehicle as a trigger, and strictly manage movement of a vehicle subjected to a movement request.

In the above aspect, the server may be configured to charge a fee for the request regarding the movement of the vehicle, the charge being based on a notification of unlocking of the vehicle and locking of the vehicle based on the issued key information, at least one of the movement requester associated with the request regarding the movement of the vehicle and the movement applicant being charged for the fee. According to this aspect, it is able to charge a fee corresponding a period of use based on notifications of unlocking and locking of a vehicle.

In the above aspect, the server may be configured to, with increase in the number of requests regarding a movement of a vehicle, decrease a fee for which the movement applicant is charged or pay a predetermined amount of money to the movement applicant. According to this aspect, for example, when there is large demand for carsharing or the like in one region but the number of vehicles distributed therein is small, a vehicle which can be used for carsharing can be moved by a movement user from another region. It is possible to solve unbalance in the distribution of vehicles which can be used for carsharing or the like.

Another aspect of the disclosure relates to an information processing device for carsharing, the information processing device including: a vehicle movement request information acquiring unit configured to acquire a piece of vehicle movement request information about a request regarding a movement of a vehicle; a movement applicant information acquiring unit configured to acquire a piece of movement applicant information about an application for a movement using a vehicle; and a key information managing unit configured to issue a piece of key information, which is for temporarily unlocking or locking the vehicle and allowing the vehicle to move, to a movement applicant based on the vehicle movement request information and the movement applicant information. Another aspect of the disclosure relates to an information processing method for carsharing, the information processing method including: using a computer to acquire a piece of vehicle movement request information about a request regarding a movement of a vehicle; using the computer to acquire a piece of movement applicant information about an application for a movement using a vehicle; and using the computer to issue a piece of key information, which is for temporarily unlocking or locking the vehicle and allowing the vehicle to move, to a movement applicant based on the vehicle movement request information and the movement applicant information. Another aspect of the disclosure relates to a non-transitory computer readable storage medium on which a program is stored, the program being configured to make a computer execute an information processing method for a carsharing system by causing the computer perform a control process for the carsharing system, the control process including: acquiring a piece of vehicle movement request information about a request regarding a movement of a vehicle by the computer; acquiring a piece of movement applicant information about an application for a movement using a vehicle by the computer; and issuing a piece of key information, which is for temporarily unlocking or locking the vehicle and allowing the vehicle to move, to a movement applicant based on the vehicle movement request information and the movement applicant information by the computer.

The disclosure can be realized as a carsharing system including at least a part of the processes or means. The disclosure can also be realized as a method of performing at least a part of the processes which are performed by the means. The disclosure can also be realized as a computer-readable storage medium storing a computer program causing a computer to execute the method. The processes or means can be freely combined unless there is technical inconsistency.

According to the disclosure, it is possible to appropriately meet needs for movement of a vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of a carsharing system according to an embodiment;

FIG. 2 is a diagram illustrating an example of a hardware configuration of a computer;

FIG. 3 is a sequence diagram illustrating an example of a flow of processes in the carsharing system;

FIG. 4 is a sequence diagram illustrating an example of a flow of processes in the carsharing system; and

FIG. 5 is a sequence diagram illustrating an example of a flow of processes in the carsharing system.

### DETAILED DESCRIPTION OF EMBODIMENTS

Hereinafter, a carsharing system according to an embodiment will be described with reference to the accompanying drawings. A configuration in the following embodiment is exemplary, and the carsharing system is not limited to the configuration in the embodiment.

### 1. System Configuration

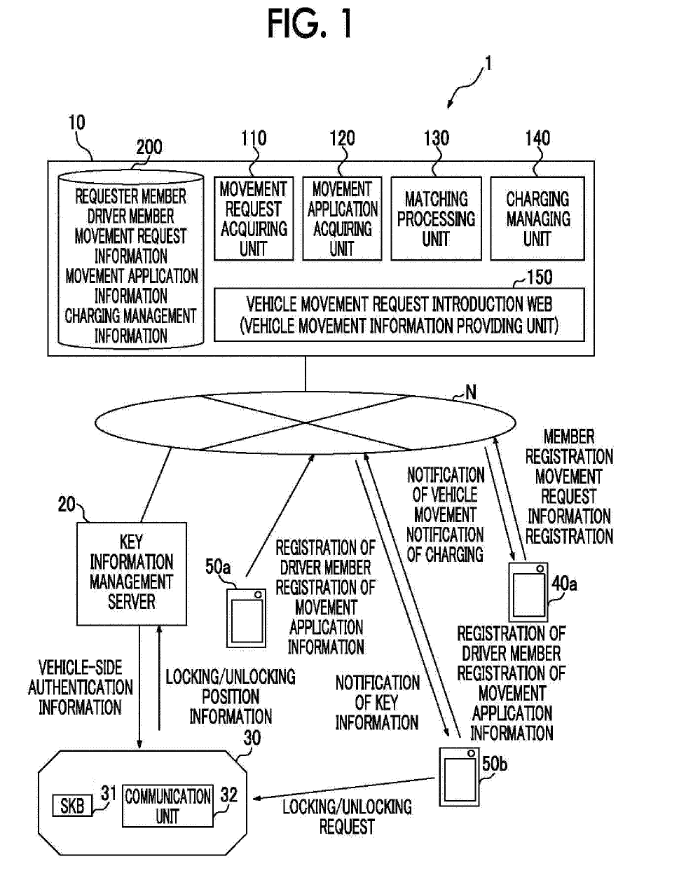

FIG. 1 is a diagram illustrating an example of a configuration of a carsharing system 1 according to an embodiment. The carsharing system 1 illustrated in FIG. 1 includes a movement support server 10 and a key information management server 20. The movement support server 10 is a computer which is used by a support company that supports matching regarding demand for movement between movement requesters who request movement of a vehicle and movement applicants who desire movement using a vehicle. Here, a “support company” is, for example, a company that provides a support service regarding demand for movement in carsharing according to this embodiment and provides a matching service regarding demand for movement of vehicles 30 that can be locked and unlocked using electronic keys. The support company may be an intermediary agent such as a trading company or an agency that mediating sale of vehicles 30. The support company may be a rental agent or a lease dealer that provides a rental service of a vehicle 30 or a loan service, or a plurality of rental agents or lease dealers may serve as the support company in cooperation with each other. The support company may be a delivery company that provides a delivery service for delivering delivery objects or the like to a delivery destination or a distributor that provides a transportation service for delivery objects or the like between bases, or a plurality of delivery companies or distributors may serve as the support company in cooperation with each other. Alternatively, an organization collaborating with a dealer or a manufacturer of vehicles 30, a branch of a manufacturer or an associated company, a trading company or an agent, a rental agent or a lease dealer, and a delivery company or a distributor may serve as the support company.

The support company provides a support service regarding demand for movement from movement requesters and movement applicants of vehicles 30 by, for example, operating a service site including the movement support server 10 and cooperating with the key information management server 20 that manages key information capable of allowing movement of a vehicle 30 with respect to vehicles 30 which can be locked and unlocked using an electronic key.

The movement support server 10 includes at least a movement support database (hereinafter also referred to as “movement support DB”) 200. The movement support server 10 provides at least information processing functions of a movement request information acquiring unit 110, a movement application information acquiring unit 120, a matching processing unit 130, a charging managing unit 140, and a vehicle movement information providing unit 150. Here, the movement support server 10 may be a single computer or may be a combination of a plurality of computers, for example, a system called a cloud. Similarly, the movement support DB 200 may be constructed by a single database server or a plurality of database servers.

In the carsharing system 1, the movement support server 10 is connected to a network N. The network N includes a public network such as the Internet, a wireless network such as a mobile phone network, a dedicated network such as a virtual private network (VPN), and a network such as a local area network (LAN).

The key information management server 20 that manages key information for allowing movement of a vehicle 30 is connected to the network N. A communication unit 32 of a vehicle 30 is also connected to the network N. A terminal 40 of a movement requester who requests movement of a vehicle 30 (hereinafter also referred to as a “request user”) is also connected to the network N. Terminals 50a and 50b of movement applicants who desire movement using a vehicle 30 (hereinafter also referred to as “movement users”) are also connected to the network N. Other key information management servers 20, communication units 32 of other vehicles 30, terminals 40 of other request users, and terminals 50a and 50b of other movement users which are not illustrated can be connected to the network N. In the following description, the terminals 50a and 50b are collectively referred to as a “terminal 50.”

The key information management server 20 is, for example, a computer such as a personal computer (PC), a workstation (WS), or a server of a management company that manages key information for allowing movement of a vehicle 30. The key information management server 20 may be a single computer or may be a system including a combination of a plurality of computers such as a cloud system. A management company including the key information management server 20 is, for example, a branch of a manufacturer of a vehicle 30 or an associated company or a company that performs work of managing key information in commission from a manufacturer or a support company.

The key information management server 20 issues key information corresponding to the form of use of a vehicle 30 by a movement user in cooperation with the movement support server 10. Here, key information is authentication information for validating a keyless entry function of a vehicle 30 that can be locked and unlocked using an electronic key. For example, vehicle-side authentication information for activating the keyless entry function may be registered in an authentication terminal 31 mounted in a vehicle 30. The vehicle-side authentication information registered in the authentication terminal 31 is managed by the key information management server 20, for example, in correlation with identification information of a vehicle 30 in which the authentication terminal 31 is mounted. When a request for issuing a one-time key (a virtual key which is valid for only one unlocking operation) has been transmitted from the movement support server 10, the key information management server 20 issues authentication information for temporarily locking and unlocking a vehicle 30 and enabling a moving operation (a driving operation) based on the vehicle-side authentication information correlated with the vehicle 30. The key information is issued, for example, as a one-time key for allowing temporary use of the vehicle 30. The issued one-time key is transmitted to a terminal 50 of a movement user via the network N. For example, when authentication of the terminal 50 in the authentication terminal 31 using the one-time key has succeeded, the movement user can unlock a boarding door of the vehicle 30 via the authentication terminal 31, board the vehicle 30, start an engine thereof, and perform a driving operation of moving and traveling from a departure point to a destination.

The key information management server 20 may generate a pair of pieces of authentication information, issue one piece of authentication information as the key information to the terminal 50, and issue the other piece of authentication information as the vehicle-side authentication information to the authentication terminal 31 mounted in the vehicle 30. In the vehicle 30, for example, the other piece of authentication information issued as the vehicle-side authentication information is received by the communication unit 32. The communication unit 32 sends the other piece of authentication information to the authentication terminal 31, for example, via an onboard network such as a controller area network (CAN) or a local interconnect network (LIN) in the vehicle 30. The authentication terminal 31 can temporarily store the sent other piece of authentication information as the vehicle-side authentication information corresponding to the key information issued to the terminal 50 in a memory or the like.

In a form in which a unit (an electronic control unit (ECU)) that performs the keyless entry function mounted in the vehicle 30 is a dedicated unit having a communication function, and a locking/unlocking key and an engine starting key of the vehicle 30 are communicated by communication, the key information management server 20 may issue the locking/unlocking key and the engine starting key as the key information. In this form, the locking/unlocking key and the engine starting key are managed by the key information management server 20. The terminal 50 to which the locking/unlocking key and the engine starting key have been issued can activate the unit that performs the keyless entry function by communication.

As issuance of key information depending on a form of use, for example, a form in which usage of the key information is limited to locking and unlocking of a trunk, a form in which usage of the key information is limited to locking and unlocking of a boarding door or a rear gate, a form in which usage of the key information is limited to permission for engine starting (deactivation of an immobilizer or the like), or a combination of the foregoing forms may be exemplified. In the following description, it is assumed that the vehicle 30 is a vehicle in which an authentication terminal (for example, a Smart Key Box (SKB)) 31 that validates the keyless entry function through authentication using the key information and a communication unit 32 are mounted as illustrated in FIG. 1.

The authentication terminal 31 of the vehicle 30 includes, for example, a communication module based on a Bluetooth (registered trademark) low-energy (BLE) communication standard. BLE is a Bluetooth-based low-energy communication standard and has characteristics that communication can be started by detecting a communication partner. The communication module included in the authentication terminal 31 may be, for example, based on another wireless communication standard such as near-field communication (NFC), ultra-wideband (UWB), and WiFi (registered trademark).

The authentication terminal 31 receives a one-time key which accompanies a locking request or an unlocking request for the vehicle 30 transmitted from the terminal 50 or the terminal 40 and which temporarily serves as an electronic key of the vehicle 30 by BLE communication. For example, the authentication terminal 31 may perform authentication when the received one-time key corresponds to the vehicle-side authentication information registered in the memory or the like in advance and not perform authentication when the received one-time key does not correspond to the vehicle-side authentication information. The “case in which the one-time key corresponds to the vehicle-side authentication information” includes a case in which the one-time key received by the authentication terminal 31 and the vehicle-side authentication information correspond to each other in a result of simple comparison and a case in which predetermined composite information is acquired by decoding the one-time key received by the authentication terminal 31 using the vehicle-side authentication information. The vehicle-side authentication information corresponding to the key information may be stored, for example, in a memory or the like in advance or may be authentication information generated by the authentication terminal 31 using the same algorithm as in the key information management server 20 based on time information or vehicle identification information. When the authentication has succeeded, locking or unlocking of the vehicle 30 corresponding to the form of use is performed.

The communication unit 32 is a wireless communication unit that can be connected to the network N. The communication unit 32 acquires a variety of information such as congestion information, road conditions, weather information, and news information corresponding to a current position of the vehicle 30 in cooperation with a car navigation device or a global positioning system (GPS) unit which is not illustrated and which is mounted in the vehicle 30. In this embodiment, the communication unit 32 may acquire predetermined authentication information (vehicle-side authentication information) corresponding to a one-time key issued by the key information management server 20 via the network N. When starting of the engine of the vehicle 30 is permitted, the communication unit 32 notifies the movement support server 10 of position information of a host vehicle via the network N. Notification of the position information of the host vehicle is performed at every predetermined time intervals or at every regular predetermined traveling distances.

A request user is an owner of the vehicle 30 or a vehicle owner having control over the vehicle. Examples of the request user include a person or a group that occupies the vehicle 30 at a time point at which a request for movement is carried out or an organization having control over the vehicle 30. Examples of an organization having control over the vehicle 30 include a company that uses the vehicle 30 as a company car, a company that provides a carsharing service, and a rental agent or a lease dealer that provides a rental service for vehicles 30 or a loan service.

The request user includes a terminal 40 which is used by a person, a member of an organization, or the like. The terminal 40 is an information processing device such as a PC, a WS, or a server. Examples of the terminal 40 include portable information processing devices such as a mobile phone, a smartphone, and a tablet PC. The request user performs requester member registration for receiving a support service regarding demand for movement which is provided by the movement support server 10 via the terminal 40. The request user requests movement of the vehicle 30 which is a movement target via the terminal 40. The terminal 40 may include a communication interface that can communicate with the authentication terminal 31 of the vehicle 30. The request user can receive a delivery object stored in the trunk of the vehicle 30 or can store a delivery object in the trunk using the terminal 40.

A movement user is a driver who drives the vehicle 30 from a departure point to a destination. The movement user carries at least a terminal 50 which is a portable information processing device such as a mobile phone, a smartphone, or a tablet PC. The terminal 50 includes a communication interface that can communicate with the authentication terminal 31 of the vehicle 30. The movement user carries out driver member registration for receiving a support service regarding demand for movement which is provided by the movement support server 10 using the terminal 50. The movement user notifies the movement support server 10 of an intention of an application for movement using the vehicle 30 to be moved via the terminal 50.

In the movement support server 10, at least requester member information, driver member information, movement request information, and movement application information are stored in the movement support DB 200.

The requester member information is member information of request users who are registered in the movement support server 10. The requester member information includes identification information for uniquely identifying a request user, an address, a contact address, a type of a request user, vehicle identification information for identifying a vehicle to be moved, an insurance number of a vehicle, and identification information of a terminal 40. The type of a request user includes information of a person, a group, a company, or the like. The vehicle identification information includes, for example, a model, a year of manufacture, engine displacement, a type of vehicle, a manufacturing serial number, and a vehicle registration number certificate (a car number). The identification information of a terminal 40 includes a phone number, an IP address, a mail address, and a media access control (MAC) address of the terminal 40 and an identification number of a support service application program (hereinafter also referred to as a “support service application”) which is provided from the movement support server 10.

The requester member information includes a term of contract, a rate schedule, a use frequency, and a payment account for the support service. The rate schedule may be classified, for example, depending on a form of use, a time of use, a use frequency, and the like of the support service. The requester member information is registered in the movement support DB 200 by the movement support server 10 or a computer cooperating with the movement support server 10 based on information at the time of member registration. The requester member information may be registered in the movement support DB 200 based on information at the time of member registration by a support company or a manager of the movement support DB 200 in commission from the support company.

The driver member information is member information of movement users who are registered in the movement support server 10. The driver member information includes identification information for uniquely identifying movement users, driving license information, contact addresses, and identification information of terminals 50. The identification information of a terminal 50 includes a phone number, an IP address, a mail address, and a MAC address of the terminal 50, and an identification number of a support service application which is provided from the movement support server 10.

The driver member information includes a term of contract and a rate schedule of a support service, a driving history, a driving record, a use record, and a payment account. The use record includes, for example, a use frequency of movement using a vehicle via the support service in a predetermined period such as a year, identification information of vehicles, a traveling distance, and moving sections. The use record may include history information indicating vehicle states at the time of traveling for movement which is acquired from a drive recorder or the like mounted in the vehicle 30. The rate schedule may be classified, for example, depending on a form of use, a time of use, and a use frequency of the support service. Registration of the driver member information in the movement support DB 200 is performed in the same way as registering the requester member information.

The movement request information is information on a request for movement of a vehicle of a request user who is registered as a requester member in the movement support server 10. A registerer of the movement request information may be, for example, a temporary user of the support service which is not registered as a requester member. A temporary user can be provided with the support service provided by the movement support server 10, for example, by registering information corresponding to the requester member information at the time of request.

The movement request information includes at least identification information for uniquely identifying a requester, information for identifying a vehicle to be moved, a desired movement schedule, and a moving section. The information for identifying a vehicle may include image information of the vehicle correlated with vehicle identification information. The desired movement schedule includes at least information for designating an arrival date and time at which the vehicle will arrive at a destination. The moving section includes position information of a departure point and a destination. Here, the moving section may include designation of a traveling route. When a traveling route is designated, delivery of luggage, pickup of an occupant, and the like at transit points can be performed, for example, by designating transit points on the route. Registration of the movement request information in the movement support DB 200 is performed in the same way as registering the requester member information.

The movement application information is information on an application for movement of a movement user as a driver member registered in the movement support server 10 using a vehicle. The movement application information includes at least identification information for uniquely identifying a movement user, a desired movement schedule, a moving section, and identification information of the terminal 50. The movement application information may include desired limitation of a moving vehicle, a desired type of a request user, whether there is luggage (a delivery object), and whether a traveling route is designated, whether delivery of luggage, pickup of an occupant, or the like at transit points are to be performed. Registration of the movement application information in the movement support DB 200 is performed in the same way as registering the requester member information.

In the carsharing system 1 according to this embodiment, the movement support server 10 supports connection between a movement requester of a vehicle 30 and a movement applicant for driving the vehicle 30 based on information stored in the movement support DB 200, movement request information including identification information of the vehicle 30 which is transmitted from the terminal 40, and movement application information which is transmitted from the terminal 50. More specifically, the movement support server 10 compares the movement request information input via the support service application of the terminal 40 with the movement application information input via the support service application of the terminal 50 and selects a movement user who drives and operates the vehicle 30 to move.

### Case 1 of Key Issuance

For example, the movement support server 10 notifies the cooperating key information management server 20 of a message indicating that a movement user associated with movement of the vehicle 30 has been selected along with the identification information of the vehicle 30. The key information management server 20 issues key information serving as a temporary electronic key, for example, based on the identification information of the vehicle 30 and time information when the message is notified from the movement support server 10. The key information is issued based on vehicle-side authentication information which is registered in the authentication terminal 31 managed by the key information management server 20. For example, the issued key information is transmitted to the terminal 50 and the terminal 40 depending on the form of use via the movement support server 10.

### Case 2 of Key Issuance

The key information management server 20 can generate a pair of pieces of authentication information based on information including the identification information of the vehicle 30 and the time information. In this case, the key information management server 20 may issue one piece of authentication information of the pair as key information for the terminals 40 and 50 and issue the other piece of authentication information as vehicle-side authentication information to the authentication terminal 31 mounted in the vehicle 30. In this case, for example, the authentication terminal 31 of the vehicle 30 may receive the other piece of authentication information issued by the key information management server 20 via the communication unit 32 and temporarily store the received authentication information as vehicle-side authentication information in a memory or the like. In the forms of “Case 1 of key issuance” and “Case 2 of key issuance”, the authentication terminal 31 of the vehicle 30 may generate vehicle-side authentication information corresponding to the key information using the same algorithm as in the key information management server 20 based on information including the identification information of the vehicle 30 and the time information when the message has been received from the movement support server 10.

### Case 3 of Key Issuance

In an aspect in which a unit (ECU) that performs the keyless entry function mounted in the vehicle 30 is a dedicated unit having a communication function and communicates a locking/unlocking key and an engine start key of the vehicle 30 by communication, the key information management server 20 may issue the locking/unlocking key and the engine start key which are managed thereby as key information. In this aspect, since communication of the issued key information between the dedicated unit and the terminal 50 is performed directly by communication, an authentication process via the authentication terminal 31 is not performed.

A movement user executes a support service application and causes the terminal 50 having received the key information to serve as a temporary electronic key for using the vehicle 30. The authentication terminal 31 of the vehicle 30 receives key information accompanying a locking request and an unlocking request for the vehicle 30 transmitted from the terminal 50, for example, by BLE communication and performs authentication on the premise that the received key information corresponds to the vehicle-side authentication information stored in the memory or the like (Case 1 of key issuance and Case 2 of key issuance). The movement user unlocks the vehicle 30 using the terminal 50 of which authentication has succeeded, and moves a moving section designated by the movement request information to a destination by driving and operating the vehicle. Alternatively, the movement user performs communication of the locking/unlocking key and the engine start key issued as the key information between the terminal 50 and the dedicated unit, unlocks a boarding door, boards the vehicle, deactives an immobilizer, starts an engine, and moves a moving section designated by the movement request information to a destination by driving and operating the vehicle (Case 3 of key issuance).

At the destination, the request user executes the support service application and causes the terminal 40 having received the key information to serve as a temporary electronic key for opening the door of the vehicle 30. The operation of the terminal 40 as the temporary electronic key is the same as that of the terminal 50 of the movement user. The request user can receive a delivery object or the like stored in a trunk of the vehicle 30 by unlocking the trunk using the terminal 40 of which authentication has succeeded using the authentication terminal 31. Alternatively, the request user communicates the locking/unlocking key issued as the key information between the terminal 40 and the dedicated unit, unlocks the trunk, and receives a delivery object stored in the trunk. In the carsharing system 1 according to this embodiment, since needs for movement of a vehicle and needs for movement using a vehicle can be made to match each other, it is possible to appropriately meet needs for movement of a vehicle.

### 2. Device Configuration

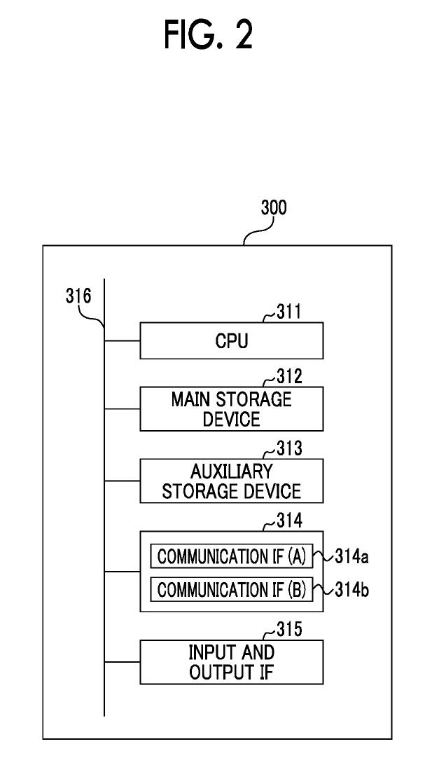

FIG. 2 is a diagram illustrating an example of a hardware configuration of a computer. The movement support server 10, the key information management server 20, the authentication terminal 31, the communication unit 32, the terminal 40, and the terminal 50 illustrated in FIG. 1 are exemplified by the configuration of a computer 300 illustrated in FIG. 2.

The computer 300 includes a central processing unit (CPU) 311, a main storage device 312, an auxiliary storage device 313, a communication interface (hereinafter referred to as “communication IF”) 314, and an input and output interface (hereinafter referred to as “input and output IF”) 315 which are connected to each other by a connection bus 316. The main storage device 312 and the auxiliary storage device 313 are storage mediums which can be read by the computer 300. The above-mentioned elements may be provided two or more, or some elements may not be provided.

The CPU 311 is a central processing unit that controls the computer 300 as a whole. The CPU 311 is also referred to as a microprocessor unit (MPU) or a processor. The CPU 311 is not limited to a single processor and may include multiple processors. A single CPU connected to a single socket may have a multi-core configuration. The CPU 311 provides a function matching a predetermined purpose, for example, by loading a program stored in the auxiliary storage device 313 into a work area of the main storage device 312 and executing the program to control peripherals. In the carsharing system 1 according to this embodiment, the processing functions of the movement support server 10, the key information management server 20, the authentication terminal 31, the communication unit 32, the terminal 40, and the terminal 50 are provided.

The main storage device 312 stores a computer programs which are executed by the CPU 311, data which is processed by the CPU 311, and the like. The main storage device 312 includes, for example, a flash memory, a random access memory (RAM), a read only memory (ROM). The auxiliary storage device 313 stores various programs and various data in a storage medium in a readable and writable manner. The auxiliary storage device 313 is also referred to as an external storage device. Examples of the auxiliary storage device 313 include a flash memory, an erasable programmable ROM (EPROM) silicon disk, and a hard disk drive (HDD) device. For example, an operating system (OS), various programs, and various tables are stored in the auxiliary storage device 313. The OS includes, for example, a communication interface program that transmits and receives data to and from an external device connected thereto via the communication IF 314. The communication IF 314 includes communication IF(A) 314A which is an interface with the network N and a communication IF(B) 314B which is a short-range wireless communication interface such as BLE communication. The movement support server 10, the key information management server 20, and the communication unit 32 may not include the communication IF(B) 314B. The authentication terminal 31 may not include the communication IF(A) 314A which is an interface with the network N.

The input and output IF 315 is an interface that inputs and outputs data to and from a device connected to the computer 300. For example, a keyboard, a pointing device such as a mouse or a touch panel, and an input device such as a microphone are connected to the input and output IF 315. The computer 300 receives an operation instruction from an operator that operates the input device via the input and output IF 315. For example, a display device such as an LCD, an electroluminescence (EL) panel, or an organic EL panel and an output device such as a speaker are connected to the input and output IF 315. The computer 300 outputs data or information which is processed by the CPU 311 or data or information which is stored in the main storage device 312 and the auxiliary storage device 313 via the input and output IF 315.

The movement support server 10 illustrated in FIG. 1 provides at least information processing functions of the movement request information acquiring unit 110, the movement application information acquiring unit 120, the matching processing unit 130, the charging managing unit 140, and the vehicle movement information providing unit 150 by causing the CPU 311 to execute a program. At least a part of the processing functions may be provided by a digital signal processor (DSP), an application specific integrated circuit (ASIC), a graphics processing unit (GPU), or the like. At least a part of the processing functions may be provided by a dedicated large-scale integration (LSI) device such as a field-programmable gate array (FPGA), a numerical processor, and an image processor or other digital circuits.

The terminal 40 and the terminal 50 illustrated in FIG. 1 are connected to the movement support server 10 by causing the CPU 311 to execute a support service application. The terminal 40 performs registration of a requester member and registration of a movement request information via an input operation by a request user. The terminal 50 performs registration of a driver member and registration of movement application information via an input operation by a movement user. Each of the terminals serves as an electronic key allowing temporary use of the vehicle 30 based on received key information by causing the CPU 311 to execute a support service application. Each terminal is connected to a service site which is operated by a support company by causing the CPU 311 to execute a browser program, and a list of movement request information of vehicles which is published on the web is provided as contents which are described in a hyper test markup language (HTML) or the like. A movement user can browse the list of movement request information of vehicles published on the web (a vehicle movement request introduction WEB) via a display device such as an LCD of the terminal 50.

### 3. Process Flow

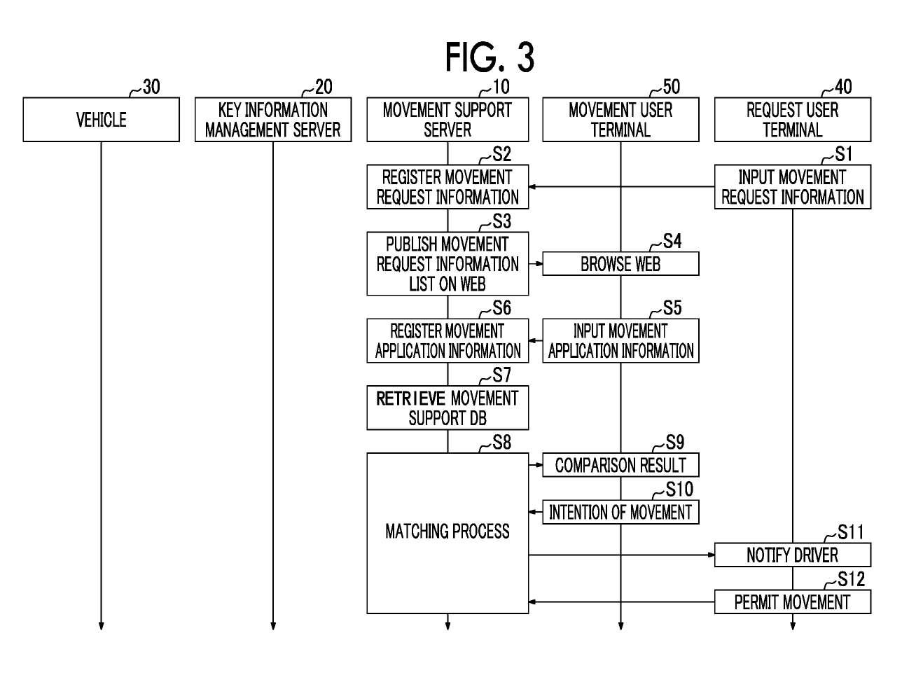

Information processing of the movement request information acquiring unit 110, the movement application information acquiring unit 120, the matching processing unit 130, the charging managing unit 140, and the vehicle movement information providing unit 150 which are provided by the movement support server 10 will be described below with reference to the sequence diagrams illustrated in FIGS. 3 to 5. FIGS. 3 to 5 are sequence diagrams illustrating an example of a process flow in the carsharing system 1. The movement support server 10 according to this embodiment provides the processes illustrated in FIGS. 3 to 5, for example, by causing the CPU 311 or the like to read and execute various programs and various data stored in the auxiliary storage device 313 and a variety of information stored in the movement support DB 200. It is assumed that requester member registration of a request user and driver member registration of a movement user have been completed in the movement support server 10 and a support service application for providing a movement support service is installed in the terminals 40 and 50.

In FIG. 3, a request user starts the support service application and inputs movement request information (S1). For example, by starting and executing the support service application, the terminal 40 logs in to the movement support server 10 and then an input screen for inputting movement request information is displayed on the LCD or the like. The request user operates, for example, the touch panel and inputs movement request information including information for identifying a vehicle 30 to be moved, a desired movement schedule, a moving section, and whether there is luggage (a delivery object). Regarding designation of a moving section, for example, map information including a moving section may be read onto the input screen and a departure point, a destination, a traveling route, or transit points on the route may be designated. The movement support server 10 may read an address or latitude and longitude of each point designated on the map and display the read data in a column to which the moving section is input.

The movement support server 10 receives the movement request information transmitted from the terminal 40 and registers the received movement request information in the movement support DB 200 (S2). The process of S2 is performed by the movement request information acquiring unit 110. The movement request information acquiring unit 110 correlates received time information with the movement request information and temporarily stores the correlated information in a predetermined area of the main storage device 312. The movement request information includes identification information such as an IP address of the terminal 40 having logged in and an identification number of the support service application which has been started and executed.

The movement request information acquiring unit 110 retrieves requester member information registered in the movement support DB 200, for example, using the log-in ID of the request user or the identification information such as the IP address of the terminal 40 included in the movement request information as a retrieval key and extracts corresponding requester member information. The extracted requester member information is temporarily stored in a predetermined area of the main storage device 312. The movement request information acquiring unit 110 registers at least the identification information for uniquely identifying the request user which is included in the requester member information and the type of the request user in the movement support DB 200 in correlation with the movement request information. The movement request information acquiring unit 110 supplies the extracted requester member information and the movement request information received from the terminal 40 to the charging managing unit 140 and the vehicle movement information providing unit 150.

The movement support server 10 publishes a movement request information list reflecting the movement request information registered in the movement support DB 200 in the process of S2 on the web (S3). The process of S3 is performed by the vehicle movement information providing unit 150. For example, the vehicle movement information providing unit 150 inserts the movement request information supplied in the process of S2 into the already published movement request information list and sorts the movement request information list using the time information included in the movement request information. In the movement request information list, for example, a text “New” is added to the head of the movement request information which is newly published, and the movement request information is sorted in the order of receiving times and is published on the web. The movement request information list published on the web may be updated, for example, in response to reception of the movement request information or at intervals of a predetermined unit time. Alternatively, the movement request information list may be updated whenever an amount of movement request information is greater than a predetermined amount. The movement request information list published on the web may be classified and displayed by local blocks, by prefectures, by municipalities, or the like, for example, based on attribute information of a departure point. The vehicle movement information providing unit 150 may publish designated conditions from the request user such as the type of the request user, image information of the vehicle 30, whether there is a delivery object, the type of a delivery object, designation of a traveling route, designation of a transit point, delivery of luggage or pickup of an occupant at a transit point, and the like along with the movement request information list including the conditions.

A movement user starts and executes a browser of the terminal 50 and acquires and browses the movement request information list published on the web S(4). Then, the movement user starts the support service application and inputs movement application information (S5). For example, by starting and executing the support service application, the terminal 50 logs in to the movement support server 10 and then an input screen for inputting movement application information is displayed on the LCD or the like. The movement user operates, for example, a touch panel and inputs movement application information including a desired movement schedule and a moving section. The movement application information may include the designated conditions from the request user such as the type of the request user, limitation of a vehicle to be moved, whether there is luggage (a delivery object), whether designation of a traveling route is permitted, and delivery of luggage or pickup of an occupant at a transit point.

The movement support server 10 receives the movement application information transmitted from the terminal 50 and registers the movement application information in the movement support DB 200 (S6). Then, the movement support server 10 retrieves the movement request information registered in the movement support DB 200 based on a variety of information included in the movement application information (S7).

The processes of S6 and S7 are performed by the movement application information acquiring unit 120.

For example, the movement application information acquiring unit 120 temporarily stores the movement application information in correlation with the receiving time information in a predetermined area of the main storage device 312. The movement request information includes identification information such as an IP address of the terminal 50 having logged in and an identification number of the support service application which has been started and executed. The movement application information acquiring unit 120 retrieves driver member information registered in the movement support DB 200, for example, using the identification information such as the IP address of the terminal 50 which is included in the movement application information as a retrieval key and extracts corresponding driver member information. The extracted driver member information is temporarily stored in a predetermined area of the main storage device 312. The movement application information acquiring unit 120 registers at least the identification information for uniquely identifying the movement user which is included in the driver member information in correlation with the movement application information in the movement support DB 200. The movement request information acquiring unit 110 supplies the extracted driver member information and the movement application information received from the terminal 50 to the charging managing unit 140.

The movement application information acquiring unit 120 retrieves the movement request information registered in the movement support DB 200 based on the information included in the movement application information received from the terminal 50 and extracts the corresponding movement request information. The movement application information acquiring unit 120 can perform searching in the movement support DB 200, for example, using terms and date and times included in the movement application information as a logical expression (AND, OR). The movement application information acquiring unit 120 correlates the extracted movement request information with the driver member information of the movement user and the movement application information and supplies the resultant to the matching processing unit 130.

The movement support server 10 performs a matching process for demand regarding movement of the vehicle 30 based on the movement request information transmitted from the terminal 40 and the movement application information transmitted from the terminal 50 (S8). The process of S8 is performed by the matching processing unit 130. In the matching process of S8, the movement request information and the movement application information are compared and a movement user for the vehicle 30 to be moved is selected.

For example, the matching processing unit 130 sorts the movement request information supplied in the process of S7 for each piece of driver member information. This is because a plurality of movement applicants may be present for one piece of movement request information. The matching processing unit 130 adds, for example, a radio button indicating an intention of movement to the movement request information sorted for each piece of driver member information and notifies the terminal 50 of each movement user as the comparison results.

The terminal 50 receives the comparison result notified from the movement support server 10 (S9). In response to reception of the comparison result, the support service application of the terminal 50 switches the input screen displayed on the LCD or the like to a display screen for displaying the comparison result. The movement user browses the comparison result displayed on the display screen of the LCD or the like and chooses desired movement request information from the movement request information displayed as the comparison result. The movement user determines an intention of movement for the desired movement request information, for example, by operating the touch panel or the like and setting the radio button added to the movement request information to a valid state (S10). The movement request information in which the intention of movement has been determined is transmitted to the movement support server 10 along with the movement request information without an intention of movement of which the radio button is invalid.

The matching processing unit 130 collects the movement request information transmitted from each terminal 50 and selects a movement user who will move the vehicle 30. The matching processing unit 130 extracts the movement request information in which the intention of movement has been determined, for example, from the movement request information received in a predetermined period.

### Case 1

When a plurality of movement users have determined an intention of movement for one piece of movement request information, the matching processing unit 130 selects a movement user from a plurality of movement users with reference to the driving history, the driving record, the use record, and the like included in the driver member information.

For example, when the movement request information includes luggage (a delivery object), the matching processing unit 130 can compare the lengths of the driving history and can sequentially select the movement users with a longer driving history. The matching processing unit 130 may select a movement user on the premise that the movement user has a driving record of a vehicle included in the model of the vehicle 30. When there is history information indicating vehicle states at the time of driving for movement acquired using a drive record as the use record, the matching processing unit 130 may select a movement user on the premise that frequencies of acceleration or deceleration, sudden start, sudden stop, and the like are small in the history information. Alternatively, the matching processing unit 130 may select a movement user on the premise that a moving section of the movement request information belongs to an area in which the movement user lives. The support company operating the movement support server 10 can determine conditions indicating reliability of driving associated with the selection in advance.

The matching processing unit 130 notifies the request user of a predetermined number of selected movement users as driver information (S11). The driving history, the driving record, the use record, and the like included in the driver member information of the movement user are added to the driver information as information indicating reliability of driving. The request user browses the driver information notified from the movement support server 10 and permits movement (S12). Permission of movement is performed, for example, by setting the radio button added to the driver information to a valid state.

When movement is not permitted, the matching processing unit 130 selects next candidates from the plurality of movement users and notifies the request user of the selected movement users as driver information. When all the movement users having an intention of movement for one piece of movement request information are not permitted, selection of movement users is performed, for example, based on the movement application information received in a next predetermined period.

The matching processing unit 130 may select a predetermined number of (about three) movement users from a plurality of movement users having an intention of movement and notify the request user of the selected movement users as driver information. The request user can browse the driver information notified from the movement support server 10 and select a movement user which is permitted for movement from the predetermined number of movement users.

For example, the matching processing unit 130 may mediate an alternative vehicle for a movement user who has not been selected. The matching processing unit 130 notifies, for example, a rental agent or a lease dealer who is registered as a requester member or who cooperates with the support company of information for identifying the vehicle 30 to be moved with an intention of movement and information such as a desired movement schedule and a moving section. The matching processing unit 130 may mediate a vehicle which is provided by a rental agent or a lease dealer who is registered as a requester member or who cooperates with the support company as an alternative vehicle.

### Case 2

When there is no movement user having an intention of movement for movement request information including luggage (a delivery object) luggage (a delivery object), for example, the matching processing unit 130 may give an incentive to a movement user who desires the same desired movement schedule and moving section as the movement request information. An example of such an incentive is an exemption of costs associated with the movement. By giving an incentive, the matching processing unit 130 can meet demand for movement for the movement request information including luggage (a delivery object).

### Case 3

As for movement request information for which there is no movement user having an intention of movement, the matching processing unit 130 may review, for example, the moving section. For example, it is assumed that the moving section designated by the movement request information includes point A as a departure point and point B as a destination. When point C is located on a moving path connecting point A and point B, the matching processing unit 130 may combine, for example, movement users having an intention of movement for movement request information with a moving section including point A and point C and movement request information with a moving section including point C and point B. The matching processing unit 130 can meet demand for movement of movement request information for which there is no movement user having an intention of movement by combining a plurality of movement users using rental cars or sharing cars.

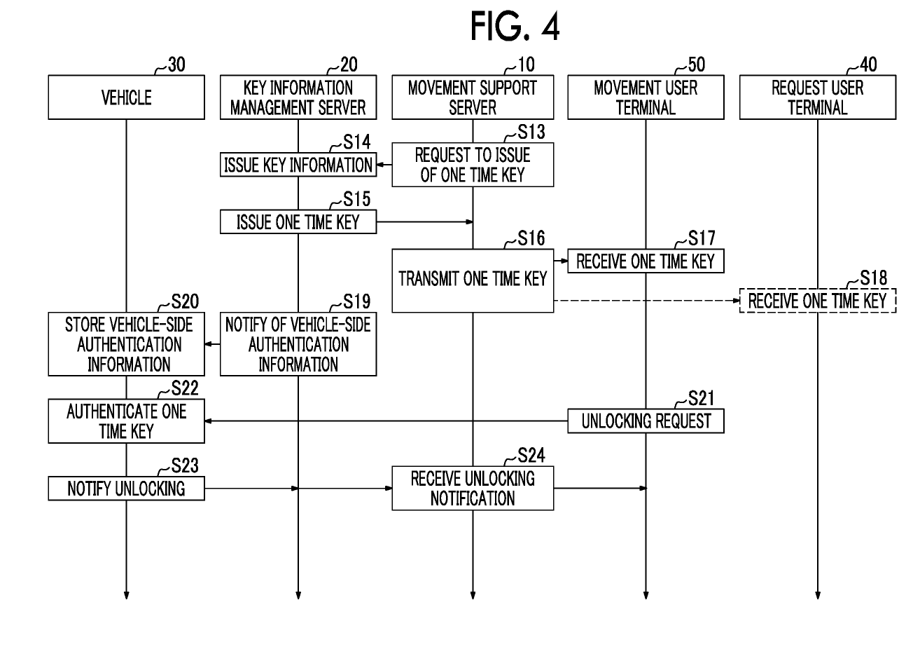

FIG. 4 will be described now. In FIG. 4, the movement support server 10 having been notified that movement of the request user is permitted, which is illustrated in S12 of FIG. 3, requests the key information management server 20 to issue a one-time key (S13). For example, the movement support server 10 transmits a request to issue a one-time key including the vehicle identification information of the vehicle 30 in the movement request information for which permission of movement is notified from the request user to the key information management server 20. When the vehicle 30 of the movement request information includes luggage (a delivery object), the movement support server 10 transmits a request for issuing a one-time key including the identification information of the request user and the identification information of the movement user.

The key information management server 20 receives the request for issuance of a one-time key from the movement support server 10 and issues key information (S14). The key information management server 20 correlates the received time information with the vehicle identification information of the vehicle 30 included in the request for issuance of a one-time key and temporarily stores the resultant in a predetermined area of the main storage device 312. Then, the key information management server 20 issues key information for causing the terminal 50 to serve as a temporary electronic key based on at least the vehicle identification information of the vehicle 30 and the time information.

In Case 1 of key issuance, the key information management server 20 issues a one-time key, for example, based on the vehicle-side authentication information combined with the vehicle identification information of the vehicle 30 and the time information. In Case 2 of key issuance, the key information management server 20 issues a pair of one-time keys, for example, based on a set of the vehicle identification information of the vehicle 30 and the time information. In Case 3 of key issuance, the key information management server 20 issues a one-time key for temporarily validating a locking/unlocking key of the vehicle 30 and an engine start key based on the time information.

When the request user is a group or the like, for example, the key information management server 20 may include identification information of the request user and identification information of the movement user in the request for issuance of a one-time key from the movement support server 10. Then, the key information management server 20 may issue key information based on the vehicle identification information of the vehicle 30, the time information, and the identification of the request user. For example, when request user A and request user B sharing a car request movement of the vehicle 30, delivery of a physical key between request user A and request user B can be skipped and thus convenience is improved. Similarly, the key information management server 20 may issue key information based on the vehicle identification information of the vehicle 30, the time information, and the identification information of the movement user. The key information management server 20 may set an available period of the key information, for example, according to a desired movement schedule included in the request for issuance of a one-time key.

The key information management server 20 transmits the issued key information as a one-time key to the movement support server 10 (S15). The movement support server 10 transmits the one-time key issued from the key information management server 20 to the terminal 50 (S16). The terminal 50 receives the one-time key transmitted from the movement support server 10 and temporarily stores the received one-time key in a predetermined area of the main storage device 312 (S17). In the process of S16, when the vehicle 30 of the movement request information includes luggage (a delivery object), the movement support server 10 transmits the one-time key issued for only the movement user to the terminal 50. Similarly, the movement support server 10 transmits the one-time key issued for only the request user to the terminal 40 (a dotted arrow). The terminal 40 receives the one-time key transmitted from the movement support server 10 and temporarily stores the received one-time key in a predetermined area of the main storage device 312 (S18).

After the process of S15, in Case 2 of key issuance, the key information management server 20 may transmit vehicle-side authentication information, which forms a pair along with the key information issued to the terminal 50 in the process of S14, to the vehicle 30 (S19). For example, the authentication terminal 31 mounted in the vehicle 30 receives the vehicle-side authentication information transmitted from the key information management server 20 via the communication unit 32 and temporarily stores the received vehicle-side authentication information in a predetermined area of the main storage device 312 (S20). At the time of authentication, the authentication terminal 31 may generate the vehicle-side authentication information using the same algorithm as in the key information management server 20 based on information including the identification information of the vehicle 30 and the time information when a notification has been received from the movement support server 10. In Case 2 of key issuance, for example, the vehicle-side authentication information corresponding to the key information issued for the movement user and the key information issued for the request user is temporarily stored in the main storage device 312 of the authentication terminal 31.

The movement user executes the support service application and causes the terminal 50 having received the key information to serve as a temporary electronic key for using the vehicle 30. The terminal 50 transmits an unlocking request for the vehicle 30, for example, by BLE communication (S21). When the vehicle 30 includes luggage (a delivery object), the electronic key can be limited to other unlocking (unlocking of a boarding door, a rear gate, an immobilizer, and the like) other than unlocking of the trunk in which luggage is stored.

In Cases 1 and 2 of key issuance, the vehicle 30 authenticates the one-time key transmitted from the terminal 50 based on the key information included in the unlocking request (S22). The authentication terminal 31 of the vehicle 30 receives the key information accompanying the unlocking request transmitted from the terminal 50, for example, by BLE communication and performs authentication on the premise that the received key information corresponds to the vehicle-side authentication information stored in the memory or the like. The authentication terminal 31 may generate the vehicle-side authentication information using the same algorithm as in the key information management server 20 based on the information including the identification information of the vehicle 30 and the time information when a notification has been received from the movement support server 10. In Case 3 of key issuance, communication of the issued key information between the dedicated unit and the terminal 50 in the vehicle 30 is directly performed by communication and thus the process of S22 is skipped.

The vehicle 30 notifies the terminal 50 of unlocking of the vehicle 30 in response to success of authentication or execution of unlocking (S23). Unlocking of the vehicle 30 is notified to the key information management server 20 and the movement support server 10 (S24). The movement support server 10 temporarily stores the time information of the unlocking notification received from the vehicle 30 in a predetermined area of the main storage device 312.

In Cases 1 and 2 of key issuance, the movement user unlocks the vehicle 30 and starts the engine using the terminal 50 having succeeded in authentication as an electronic key. In Case 3 of key issuance, the terminal 50 storing the locking/unlocking key and the engine start key of the vehicle 30 is used as an electronic key. The movement user drives and operates the started vehicle 30 and moves to the destination designated by the movement request information.

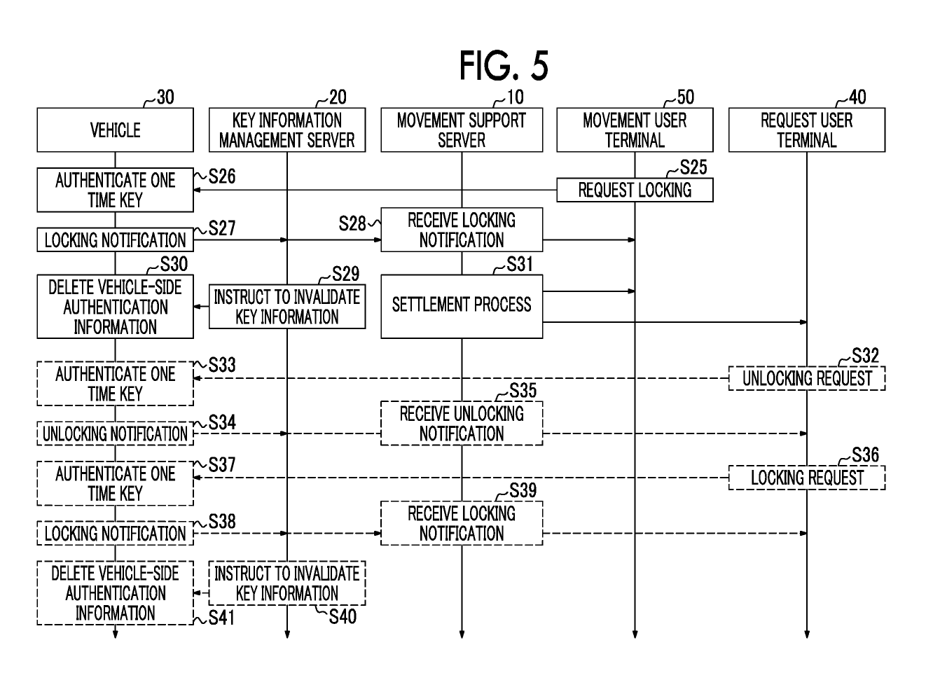

FIG. 5 will be described below. In FIG. 5, the movement user reaching the designated destination in a moving section stops and gets out of the vehicle 30 and transmits a locking request to the vehicle 30 using the terminal 50 serving as an electronic key (S25).

In Cases 1 and 2 of key issuance, the vehicle 30 authenticate a one-time key transmitted from the terminal 50 based on the key information included in the locking request (S26). The authentication terminal 31 of the vehicle 30 receives key information accompanying the locking request transmitted from the terminal 50 by BLE communication or the like and performs authentication on the premise that the received key information corresponds to predetermined authentication information (vehicle-side authentication information) corresponding to the key information stored in the memory or the like. The vehicle 30 notifies the terminal 50 of locking of the vehicle 30 in response to success of authentication or execution of locking (S27). Locking of the vehicle 30 is notified to the key information management server 20 and the movement support server 10 (S28). The movement support server 10 temporarily stores the time information of the locking notification received from the vehicle 30 in a predetermined area of the main storage device 312. In Case 3 of key issuance, communication of the issued key information between the dedicated unit and the terminal 50 in the vehicle 30 is directly performed by communication. Accordingly, the process of S26 is skipped.

The key information management server 20 having received the locking notification transmits an instruction to invalidate the key information to the vehicle 30 (S29). The authentication terminal 31 mounted in the vehicle 30 receives the key information invalidation instruction transmitted from the key information management server 20 via the communication unit 32 and deletes the vehicle-side authentication information temporarily stored in the predetermined area of the main storage device 312 (S30). The authentication terminal 31 may store the conditions for issuing the one-time key, for example, the combination of the identification information of the vehicle 30 and the time information as an invalidation list in the memory. The authentication terminal 31 can prohibit issuance of a one-time key accompanying authentication with the terminal 50 based on the combination of the identification information of the vehicle 30 and the time information included in the invalidation list. The movement support server 10 having received the locking notification may transmit an instruction to delete the key information to the terminal 50. The support service application of the terminal 50 can delete the key information temporarily stored in the predetermined area of the main storage device 312 of the terminal 50 based on the key information deletion instruction transmitted from the movement support server 10.

The movement support server 10 having received the locking notification performs a settlement process associated with the movement support service (S31). The settlement process of S31 is performed by the charging managing unit 140. The charging managing unit 140 calculates a period of use of the vehicle 30, for example, based on the time information of the unlocking notification and the time information of the locking notification received from the vehicle 30. Then, the charging managing unit 140 calculates a fee associated with the movement support service based on the requester member information supplied from the movement request information acquiring unit 110 and the driver member information supplied from the movement application information acquiring unit 120.

The charging managing unit 140 calculates a fee for the request user, for example, based on the rate schedule included in the requester member information and the period of use. The charging managing unit 140 calculates a fee for the movement user, for example, based on the rate schedule included in the driver member information and the period of use. The charging managing unit 140 notifies the terminal 40 and the terminal 50 of the fees associated with the movement support service, which are calculated for the request user and the movement user. The fees associated with the movement support service are presented to the users via a display screen of the LCD or the like of the terminals.

The movement support server 10 may decrease the fee for the movement user or return a predetermined amount of money to the movement user with an increase in the number of requests regarding movement using a vehicle. For example, the movement support server 10 can prepare a rate schedule of a plurality of steps included in the driver member information and switch a rate schedule (a decreased rate schedule or a rate schedule of returning money) to be applied with an increase in the number of requests regarding movement using a vehicle. In the carsharing system 1 including the movement support server 10, for example, when there is large demand for carsharing or the like in one region but the number of vehicles distributed therein is small, a vehicle which can be used for carsharing can be moved by a movement user from another region. It is possible to solve unbalance in the distribution of vehicles which can be used for carsharing or the like. A support company of carsharing or the like including the movement support server 10 can expect an overall increase in sales account. In the settlement process of S31, decrease in a fee charged for the movement user or return of a predetermined amount of money for the movement user with an increase in the number of requests regarding movement using a vehicle is an example of settlement means that decreases a fee charged form the movement applicant or returns a predetermined amount of money to the movement applicant with an increase in the number of requests regarding movement using a vehicle.

In FIG. 5, the processes of dotted arrows and S32 to S41 surrounded with dotted frames denote a process flow using the electronic key for the request user when the vehicle 30 includes luggage (a delivery object). In the processes of S32 to S41, the request user receives a delivery object stored in the trunk using the key information of a one-time key for unlocking and locking the trunk in which luggage is stored. The processes of S32 to S35 are the same as the processes of S21 to S24 described above with reference to FIG. 4, and the processes of S36 to S41 are the same as the processes of S25 to S30 described above with reference to FIG. 5.

### Advantages of Embodiment

In the carsharing system according to this embodiment, a movement applicant having received a request for movement of a vehicle can use a mobile terminal storing issued key information as an electronic key including temporary authentication information for driving and operating the vehicle. The movement applicant can unlock the vehicle using the mobile terminal serving as an electronic key and move the vehicle to a destination which is designated by the movement request. With the carsharing system, since a movement applicant carrying a terminal having key information stored therein serves as a temporary key manager and drive and operate a vehicle, it is possible to appropriately meet needs for movement of a vehicle.

The carsharing system according to this embodiment can publish one or more pieces of vehicle movement request information as a vehicle list on the web site. A movement applicant who desires movement using a vehicle can select a desired movement request by browsing the vehicle movement request information published on the web site.

The carsharing system according to this embodiment can receive an application for movement using a vehicle in the vehicle list as movement applicant information. The carsharing system can collect movement applicants corresponding to the vehicles in the vehicle list.

In the carsharing system according to this embodiment, since the vehicle movement request information and the movement applicant information are compared with each other and a movement applicant is selected based on the comparison result, it is possible to adjust requirements or use conditions between the vehicle movement requests and the movement applicants.

In the carsharing system according to this embodiment, since key information can include available period information depending on a form of use of a vehicle, an available period of a mobile terminal serving as an electronic key can be limited. Accordingly, it is possible to restrain use of a mobile terminal serving as an electronic key of which the available period has expired.

In the carsharing system according to this embodiment, since key information can be invalidated when it has been notified that a vehicle has locked based on the issued key information, it is possible to strictly manage movement of a vehicle subjected to a movement request.

The carsharing system according to this embodiment can charge a fee for a request regarding movement of a vehicle to at least one of a movement requester associated with the request for movement of a vehicle and a movement applicant based on notification of unlocking of the vehicle and locking of the vehicle based on the issued key information. The carsharing system can charge a fee depending on a period of use based on notifications of unlocking and locking of a vehicle.

The carsharing system according to this embodiment can decrease a fee for a movement applicant or return a predetermined amount of money with an increase in the number of requests for movement of a vehicle. The carsharing system can solve unbalance in the distribution of vehicles which can be used for carsharing or the like.

### 4. Modified Example

The above-mentioned embodiment is an example and the disclosure can be appropriately modified without departing from the gist thereof

In the embodiment, a vehicle 30 of which use for movement is managed using a one-time key has been exemplified, but the target associated with use for movement may be a two-wheel vehicle such as a bicycle or a motorbike or equipment such as a ship or a drone. For example, the equipment to be operated associated with the use for movement in the modified example includes an authentication device which can be used for locking and unlocking using key information managed by the key information management server 20 as a one-time key. The authentication device can transmit and receive a locking/unlocking request including key information to and from a mobile terminal of a movement user serving as a one-time key, and thus the equipment can be used for movement in different time zones by a plurality of users. Computer-readable storage medium

A program causing an information processing device or other machines or devices (hereinafter referred to as a computer or the like) to execute one of the above-mentioned functions can be recorded on a computer-readable storage medium. By causing the computer or the like to read and execute the program of the storage medium, the function can be provided.

Here, the computer-readable storage medium refers to a storage medium which can store information such as data or programs by an electrical, magnetic, optical, mechanical, or chemical action and be read by the computer or the like. Examples of the storage medium which can be detached from the computer or the like include a flexible disk, a magneto-optical disk, a CD-ROM, a CD-R/W, a DVD, a Blu-ray disc, a DAT, a 8 mm tape, and a memory card such as a flash memory. Examples of the storage medium fixed to the computer or the like include a hard disk and a ROM.

What is claimed is:

1. A carsharing system comprising a server configured to:
acquire a piece of vehicle movement request information about a request regarding a movement of a vehicle;
acquire a piece of movement applicant information about an application for a movement using a vehicle; and
issue a piece of key information, which is for temporarily unlocking or locking the vehicle and allowing the vehicle to move, to a movement applicant based on the vehicle movement request information and the movement applicant information.

2. The carsharing system according to claim 1, wherein the server is configured to publish one or more pieces of the acquired vehicle movement request information as a vehicle list on a web site.

3. The carsharing system according to claim 2, wherein the server is configured to:
receive an application for a movement using a vehicle in the vehicle list; and
acquire the movement applicant information by receiving the application for movement using the vehicle in the vehicle list.

4. The carsharing system according to claim 3, wherein the server is configured to compare the vehicle movement request information with the movement applicant information and select a movement applicant based on a result of such a comparison.

5. The carsharing system according to claim 1, wherein the key information includes a piece of available period information corresponding to a form of movement using the vehicle.

6. The carsharing system according to claim 1, wherein the server is configured to invalidate the key information issued by the server when a notification indicating that the vehicle has been locked by using the key information has been received.

7. The carsharing system according to claim 1, wherein the server is configured to charge a fee for the request regarding the movement of the vehicle, the charge being based on a notification of unlocking of the vehicle and locking of the vehicle based on the issued key information, at least one of the movement requester associated with the request regarding the movement of the vehicle and the movement applicant being charged for the fee.

8. The carsharing system according to claim 7, wherein the server is configured to, with increase in the number of requests regarding a movement of a vehicle, decrease a fee for which the movement applicant is charged or pay a predetermined amount of money to the movement applicant.

9. An information processing device for carsharing, the information processing device comprising:
a vehicle movement request information acquiring unit configured to acquire a piece of vehicle movement request information about a request regarding a movement of a vehicle;
a movement applicant information acquiring unit configured to acquire a piece of movement applicant information about an application for a movement using a vehicle; and
a key information managing unit configured to issue a piece of key information, which is for temporarily unlocking or locking the vehicle and allowing the vehicle to move, to a movement applicant based on the vehicle movement request information and the movement applicant information.

10. An information processing method for carsharing, the information processing method comprising:
using a computer to acquire a piece of vehicle movement request information about a request regarding a movement of a vehicle;
using the computer to acquire a piece of movement applicant information about an application for a movement using a vehicle; and
using the computer to issue a piece of key information, which is for temporarily unlocking or locking the vehicle and allowing the vehicle to move, to a movement applicant based on the vehicle movement request information and the movement applicant information.

11. A non-transitory computer readable storage medium on which a program is stored, the program being configured to make a computer execute an information processing method for a carsharing system by causing the computer perform a control process for the carsharing system, the control process comprising:
acquiring a piece of vehicle movement request information about a request regarding a movement of a vehicle by the computer;
acquiring a piece of movement applicant information about an application for a movement using a vehicle by the computer; and
issuing a piece of key information, which is for temporarily unlocking or locking the vehicle and allowing the vehicle to move, to a movement applicant based on the vehicle movement request information and the movement applicant information by the computer.
